(19) United States
(12) Patent Application Publication
(10) Pub. No.: US 2007/0209050 A1
(43) Pub. Date: Sep. 6, 2007

(54) Method and receiver for generation of lists of favorite services

(76) Inventor: Sebastien Fraleu, Noyal sur Vilaine (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/562,663

(22) PCT Filed: Jul. 2, 2004
(86) PCT No.: PCT/FR04/50309

§ 371 Date: Mar. 20, 2007

(30) Foreign Application Priority Data
Jul. 3, 2003 (FR) 03/08082

(51) Int. Cl. H04N 7/20

(52) U.S. Cl. 725/63

(57) ABSTRACT

The invention relates to a method for generation of a list of favourite services (FAVi) in a receiver (1) suitable for receiving audio and/or video digital services comprising means of storage (4) of a first list of available services (LG) in which each service possesses a unique identifier. The method comprises the steps of recovery of a second list of services (TDS) comprising for each service the unique identifier and at least one value of selection criterion; of determination of a subset of the second list of services as a function of at least one criterion for selecting and creating the said list of favourite services on the basis of the common services between the first list of available services and the subset of the second list of services. The invention also relates to a corresponding receiver.

### FIELD OF THE INVENTION

The invention pertains to a method for constructing a list of favourite services in a decoder of audio and/or video digital services maintaining in memory a list of the services available in the form of a global list identifying each available service.

### BACKGROUND ART

An available service is a programme which a digital decoder, after installation in a determined geographical zone, can actually decode and present to the user. The latter selects the service that he wishes to view either directly from the global list, or from one of his lists of favourite services (subset of the global list).

By service identifiers is understood to mean the n-tuple of information making it possible to identify in a unique manner a transmitted digital service. In the case of the DVB standard (standard “ETSI EN 300 468—Digital Video Broadcasting; Specification for Service Information (SI) in DVB systems”), each service is identified by its trio of DVB identifiers: the “Original Network Id” (identifier of the origin network—one and the same service possibly being resent over several networks ), the “Transport Stream Id” (identifier of the transport stream) and the “Service Id” (service identifier). Likewise in the case of the DSS system (the acronym standing for “Digital Satellite System”) the “Channel number” and the identifier of its PTC table (the acronym standing for “Physical Transmission Channel”) define a service.

The gamut of audio and/or video digital services (TV, radio, interactive programmes) offered to users by transmission operators (CanalSAT, TPS, BLOOMBERG, etc.) is ever larger, all the more so since a digital decoder can be linked to antennas pointing at several satellites for transmitting digital services. A digital decoder is currently capable of managing around 5000 digital services. As a result, the user needs to organize in a practical manner the services available in the form of one or more lists of favourite services.

Up to now, to construct a list of favourite services, the user scrolls, with the aid of a remote control, the global list of available services that is maintained in memory in the decoder and points manually one by one at each service that he wishes to input into the list of favourite services. This procedure for constructing a list of favourite services is lengthy and tiresome, thus making it ever more unsuitable for the growth in the gamut of services.

### SUMMARY OF THE INVENTION

The invention is aimed at alleviating the drawback indicated above.

The idea underlying the invention is to offer the user an aid for the automatic construction of the list of favourite services by inputting, for example with the aid of a remote control, at least one selection criterion into the decoder which corresponds in its simplest form to a type of service (for example: “Sport”, “Cinema”, “Info”), to a relevant public (for example: “Child”, “Adult”, “Man”, “Woman”), to the language used (for example: “French”, “English”) to the scrambling, (for example: “plaintext”, “scrambled”), etc. The thus-constructed list of favourite services comprises all the services arising from the global list meeting this criterion.

For this purpose, the subject of the invention is a method for constructing a list of favourite services in a receiver suitable for receiving audio and/or video digital services comprising means of storage of a first list of available services in which each service possesses a unique identifier,
characterized in that the method comprises the steps of:
(a) recovery of a second list of services comprising for each service the unique identifier and at least one value of selection criterion;
(b) determination of a subset of the second list of services as a function of at least one selection criterion;
(c) creation of the said list of favourite services on the basis of the common services between the first list of available services and the subset of the second list of services.

The first list may for example be determined, if the implementation is performed within the DVB framework, on the basis of tables transmitted referred to as “NIT” tables (network description tables). Other tables may be used. The second list may advantageously be sent in a private section of an MPEG multiplexed stream or be downloaded from a server across a network to which the receiver is connected, typically a telephone or cable network.

The method can moreover comprise a step consisting in establishing a match between a description of a selection criterion, input by the user, and at least one selection criterion stored in the second list by virtue of a table of criteria containing the number of possible selection criteria and a description of all the selection criteria.

The selection criterion may be simple or more structured as a function of the selection criterion fields that have been envisaged in the services description table. For example, if the services description table comprises two selection criterion fields corresponding for example respectively to a type of service (“Sport”, “Cinema”, “Info”) and to a type of public (“Child”, “Adult”, “Man”, “Woman”), a structured selection criterion may consist in the selection of the “Cinema” AND “Child” services. The selection criterion input in step (a) may in particular be a logical combination of selection criteria contained in the table of criteria.

The method may also comprise a step of automatic construction of at least one list of favourite services on the basis of default selection criteria contained in a default criteria table.
receiver of audio and/or video digital services comprising means of storage of a first list of actually available services in which each service possesses a unique identifier, characterized in that it furthermore comprises
   means of storage of a second list of services comprising for each service at least one value of selection criterion,
   means for creating a favourite list that are designed to receive at least one selection criterion and to establish a favourite list by determination of the services of the second list corresponding to the said at least one selection criterion and present also in the first list of services.

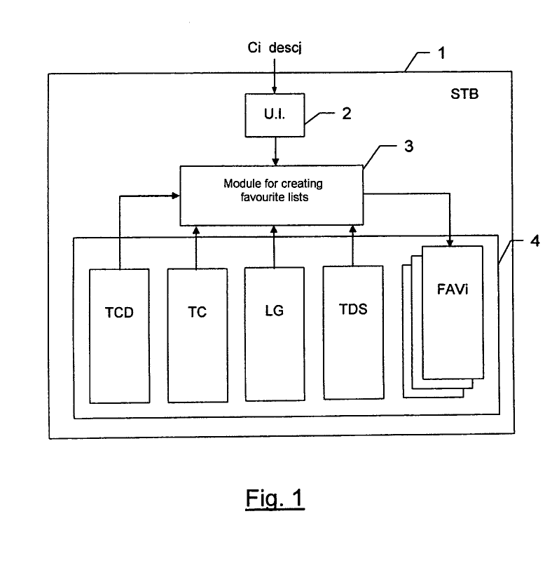

The method according to the invention is described hereinbelow and illustrated in the single figure (FIG. 1) which diagrammatically represents an STB digital decoder.

FIG. 1 illustrates the elements necessary for the understanding of the invention in an STB digital decoder 1. The decoder 1 conventionally contains a global list of the digital services available accessible by the decoder. This list is contained in a memory 4 of the decoder 1 in the form of a global list LG identifying each service available by an n-tuple of identifiers. Each n-tuple of identifiers may be supplemented with another item of information such as the name of the service. However, to construct a list of favourite services, the user needs discriminatory information of higher level characterizing each service. This discriminatory information is for example:
the type of emission transmitted: general interest, sport, cinema, young people, information, etc.
the public at which the emission transmitted is aimed: any public, adolescents, children, adults, men, women, etc.
the encryption: plaintext, scrambled,
the language of the emission transmitted: English, French, etc.
etc.

According to the invention, this discriminatory information is stored in fields of a Services Description Table (TDS) matched with n-tuples of identifiers of digital services, so as to serve as selection criteria during the construction of a list of favourite services by the user. This TDS table, stored in the memory 4 of the decoder, may be rendered accessible to the decoder from a channel for receiving digital services or from an Internet connection on a remote server. The TDS table may also be embedded in the decoder during its manufacture (in this case provision is advantageously made for a possibility of updating the TDS table, for example via a connection to a remote server). This TDS table is designed to catalogue a priori all the digital services accessible in a certain geographical zone (or the union of several adjoining zones) where the decoder is supposed to be installed. For example, in France, a decoder may be installed today on “TPS” and/or “CanalSAT” and/or “ViaDigital”. The TDS table for a decoder installed in France will therefore catalogue all the digital services of “TPS”, “CanalSAT” and “ViaDigital”.

In the case of the aforesaid DVB standard, the service identifiers are a trio of values (“Original Network Id”-“Transport Stream Id”-“Service Id”) which are coded on 6 bytes. If we assume, in a non-optimized embodiment, that the discriminatory information or selection criteria may be coded on 2 bytes, then the size of the non-optimized TDS table will be a maximum of 40 kbytes for cataloguing 5000 digital services.

More advantageously, it is possible to opt for the following optimized format in the case of the DVB standard:

TDS = {

| table_id | : 1 byte: Type of table |
|---|---|
| version_id | : 1 byte: Identification of the version of the TDS table |
| structure_id: 1 byte: Identification of the structure of the TDS table | |
| nb_onid | : 1 byte: Number of “Original Network Id” in the |
| | TDS table |

{/* Loop over all the ON_id */

| | |
|---|---|
| ON_id | : 2 bytes: Identifier of the “Original Network Id” |
| nb_tsid | : 1 byte: number of associated “Transport Stream |
| | Id” on the |

network having as identifier ON_id

{/* Loop over all the TS_id of this network */

| | |
|---|---|
| TS_id | : 2 bytes: “Transport Stream Id” identifier |
| Nb_services | : 1 byte: number of services on the transport |
| | stream |

having as identifier TS_id

{/* Loop over the services tied to this pair (ON_id, TS_id) */

| | |
|---|---|
| S_id | : 2 bytes: “Service Id” identifier |
| C1_id | : 1 byte: criterion 1 = Type |
| C2_id | : 4 bits: criterion 2 = Public |
| C3_id | : 4 bits: criterion 3 = Encryption |

} /* End loop over the services

} /* End loop over all the TS_id */

} /* End loop over all the ON_id */

}

With this optimized structure, for 5000 services transmitted over 10 networks (ON_id), at a rate of 25 transport streams (TS_id) per network and of 20 services (S_id) per transport stream (values given by way of indication), the size of the TDS will be: 4+10×(3+25×(2+1+20×(2+2))), i.e. 20 784 bytes (to be compared with the 40 000 bytes required when using a non-optimized format).

The structure_id field makes it possible to define various structures of TDS tables. It is possible to contemplate simple structures (of reduced size) for low speed transmissions and cheap decoders and advanced structures carrying a large number of criteria for the high-end decoders.

In our case we assume that the structure_id field has a value such that the TDS table contains the following fields for defining the services selection criteria:
C1_id=Type, able to take one of the following values {1: “Sport”, 2: “Cinema”, 3: “Info”}
C2_id=Public, able to take one of the following values {1: “Adult”, 2: “Child”, 3: “Woman”}
C3_id=Encryption, able to take one of the following values {1: “plaintext”, 2: “scrambled”.

The match between the value of the criterion and its character string (for example between 0x01 et “Sport”) is effected via another table that we shall call the Table of Criteria TC which is also stored in the memory 4 of the decoder 1.

This table TC is for example defined by the following structure:

TC = {

| table_id | : 1 byte: Type of table |
|---|---|
| version_id | : 1 byte: Identification of the version of the TC table |
| structure_id : 1 byte: Identification of the structure of the TDS table | |
| used | |
| nb_criteria | : 1 byte: number of different criteria |

{/* Loop over all the criteria */

Ci_name: 12 bytes: string: name of criterion (for example: “Type”,

“Public”, “Encryption” etc.)

nb_value: 1 byte: number of possible values for this criterion
{/* Loop over the names for criterion Ci */

Ci_valj : 1 byte: the value of criterion Ci (for example 1)

Ci_descj: 12 bytes: the character string (for example = “Sport”)
} /* End loop over the names for criterion Ci */

} /* End loop over all the criteria */

}

According to the invention it is possible to dynamically manage the number of criteria and the names allocated to these criteria via the Table of Criteria TC. This table TC matches the digital value of the “Type”, “Public”, “Encryption”, etc. field used in the Services Description Table TDS with the character string which denotes this criterion. This Table of Criteria TC is in the same way as the TDS table transmitted, downloadable or embedded. It is then possible to reupdate the criteria used in the digital decoder 1.

To construct a list of favourite services FAVi, the user inputs at least one predetermined selection criterion Ci_descj by way of a user interface module UI 2 of the decoder 1. The selection criterion may pertain to a type of service, a public relevant to the service, the language of the service, the encryption, etc. when the selection criterion is an item of discriminatory information forming part of a field of the Services Description Table TDS. In response to the input of the selection criterion, a software module 3 for creating favourites lists situated in the decoder is designed to retrieve from the TDS table the identifiers (for example the DVB trios) meeting the selection criterion input into the decoder and to cross-check the identifiers of the global list LG with the identifiers retrieved from the TDS so as to construct the list of favourite services FAVi corresponding to the selection criterion input into the decoder.

The selection criterion may be simple or more structured depending on the interpretation capabilities of the software module 3. In particular, it is conceivable for the selection criterion to be a combination of several criteria using AND/OR logical operators, etc.

For example, the following complex criterion may be defined:
CC1_val=2 and (2 or 3) and 1.
With the value of structure_id chosen above, this complex criterion corresponds to the selection of stations:
of type “Cinema” (which C1_id of description of type equals 2) and;
of public “Child” (which C2_id of description of public equals 2) or of public “Woman” (which C2_id of description of public equals 3) and;
of encryption “plaintext” (which C3_id of description of encryption equals 1).

According to a preferred embodiment of the invention, the decoder 1 after installation, proposes the automatic construction of a certain number of lists of favourite services on the basis of a Default Criteria Table (TCD) contained in the memory 4 of the decoder 1, by cross-checking with the list of available services (LG). This TCD table contains a subset of the criteria authorized by the information contained in the TDS table. This table of default criteria (TCD) is either downloaded, or embedded in the decoder during its manufacture. After this automatic initialization, the user can then modify the number of lists of favourite services, their names, their contents and their respective selection criteria with the aid of the user interface 2 and of the module for creating the favourites lists 3.

The structure of the TCD table is for example as follows:

TCD = {

| | |
|---|---|
| table_id | : 1 byte: Type of table |
| version_id | : 1 byte: Identification of the version of the TCD table |
| stucture_id | : 1 byte: Identification of the structure of the TDS table |
| | used |
| nb_criteria | : 1 byte: number of different criteria in the TCD table |

{/* Loop over all the criteria */

CCi_val: 24 bytes: character string (for example = “2.(2+3).1”

with “+” signifying or and “.” signifying and)

etc.

} /* End loop over all the criteria */

}

The structure_id field must be identical for the three tables so as to ensure consistency between the data of the various tables. The STB decoder 1 supports a given value of structure_id and therefore takes account only of the tables, teletransmitted and/or downloaded, comprising this value of structure_id. The three tables TDS, TC and TCD each comprise a version number which changes with each update of the contents of these tables (which number is defined in the version_id field). Hence it is possible to modify them and to update them. When an update is necessary, the operator transmitting the services provides a new value of version_id which is either teletransmitted to all the decoders, or made available on an update server to which the decoders can connect to obtain a download of the value of version_id. Each decoder then compares the value of version_id of each of the tables TDS, TC and TCD that it has in memory 4 with the value of version_id of the tables teletransmitted and/or made available and having the same structure_id as the decoder. In the event of a difference, the decoder replaces the content of the old tables stored in memory with the content of the new ones.

Of course, after a list of favourite services FAVi has been constructed, it is saved in the memory 4 of the decoder 1 so that the user can always modify it using the basic functionalities conventionally available on decoders. Moreover, the selection criteria may also be applied to a list of services other than the global list of services LG, for example to another list of favourite services FAVi compiled beforehand, so as to compile a new list of favourite services FAVj with more restrictive criteria.

1. A Method for constructing a list of favourite services in a receiver suitable for receiving audio and/or video digital services comprising means of storage of a first list of available services in which each service possesses a unique identifier,
wherein the method comprises the steps of:
(a) recovery of a second list of services comprising for each service the unique identifier and at least one value of selection criterion;
(b) determination of a subset of the second list of services as a 15 function of at least one selection criterion;
(c) creation of said list of favourite services on the basis of the common services between the first list of available services and the subset of the second list of services.

2. The method according to claim 1, in which the first list of services is a list of the services available in the digital streams actually received by the receiver.

3. The method according to claim 1, wherein the second list comprises at least the services potentially receivable by the receiver and in that the first list is a subset of the second list.

4. The method according to claim 1, wherein the selection criterion of step (b) is a selection criterion or a logical combination of selection criteria entered by a user on the basis of the criteria of the second list.

5. The method according to claim 1, wherein step (b) comprises a step for determining a default criterion or a logical combination of default selection criteria.

6. The method according to claim 5, wherein steps (b) and (c) are repeated for several default selection criteria or logical combinations of default selection criteria to create a plurality of default favourite services lists.

7. The method according to claim 1, wherein the second list is:
sent by transmission on a channel able to be received by the receiver;
accessible in the receiver by downloading from a remote server; or
embedded in the receiver.

8. The method according to claim 1, wherein the first list is extracted from stream description tables included in the stream or streams actually received by the receiver, the said stream description tables indicating the services transmitted in the received stream or streams.

9. The method according to claim 1, wherein a step of updating at least one from among the first and the second list by transmission in a stream able to be received by the decoder or by downloading from a server.

10. A receiver of audio and/or video digital services comprising means of storage of a first list of actually available services in which each service possesses a unique identifier, wherein it furthermore comprises
means of storage of a second list of services comprising for each service at least one value of selection criterion,
means for creating a favourite list that are designed to receive at least one selection criterion and to establish a favourite list by determination of the services of the second list corresponding to the said at least one selection criterion and present also in the first list of services.
